(19) United States
(12) Patent Application Publication
(10) Pub. No.: US 2026/0166690 A1
(43) Pub. Date: Jun. 18, 2026

(54) ROTARY IMPULSE TOOL

(71) Applicant: TECHTRONIC CORDLESS GP, Anderson, SC (US)

(72) Inventors: Matthew S. Samstag, Belton, SC (US); Garrett C. Gerdes, Greenville, SC (US); Joshua P. Collins, Easley, SC (US); Curt A. Laugh, Anderson, SC (US); Elton L. Watson, Greenville, SC (US)

(21) Appl. No.: 18/983,972

(22) Filed: Dec. 17, 2024

(51) Int. Cl. B25B 21/02; B25D 17/06

(52) U.S. Cl. CPC B25B 21/02; B25D 17/06; B25D 2217/0015

(57) ABSTRACT

A power tool may include a housing, a motor, an impulse assembly supported within the housing and configured to be driven by the motor, the impulse assembly including an anvil assembly and a hammer assembly configured to impart a torque impulse to the anvil assembly, the hammer assembly including a drum assembly defining an inner surface, and the anvil assembly including an anvil including an output end configured to removably support the tool bit, the anvil defining a longitudinal bore, a slot, and a first transverse aperture, a plug received into the longitudinal bore, the plug defining a second transverse aperture, a blade assembly including a blade at least partially received into the slot and a spring extending through the first transverse aperture and the second transverse aperture, the spring biasing the blade toward the inner surface of the drum assembly.

### FIELD

The present disclosure relates to power tools, and more particularly, to impulse power tools.

### BACKGROUND

Impulse power tools can deliver torque impulses to a workpiece at high speeds by accumulating energy in a rotating mass and transmitting the energy to an output shaft. The output shaft may be capable of holding a tool bit or engaging a socket. Impulse tools typically utilize percussive transfers of high momentum, which is transmitted through the output shaft using a variety of means, such as electric or electromagnetic mechanisms, oil-pulse mechanisms, mechanical-pulse mechanisms, or any suitable combination thereof.

### SUMMARY

The disclosure provides, in one aspect, a power tool configured to deliver torque impulses to a tool bit, the power tool including: a housing; a motor supported within the housing; and an impulse assembly supported within the housing and configured to be driven by the motor, the impulse assembly including an anvil assembly and a hammer assembly configured to impart a torque impulse to the anvil assembly, the hammer assembly including a drum assembly defining an inner surface, and the anvil assembly including an anvil including an output end configured to removably support the tool bit, the anvil defining a longitudinal bore, a slot, and a first transverse aperture, a plug received into the longitudinal bore, the plug defining a second transverse aperture, a blade assembly including a blade at least partially received into the slot and a spring extending through the first transverse aperture and the second transverse aperture, the spring biasing the blade toward the inner surface of the drum assembly.

The disclosure provides, in another aspect, a power tool configured to deliver torque impulses to a tool bit, the power tool including: a housing; a motor supported within the housing; and an impulse assembly supported within the housing and configured to be driven by the motor, the impulse assembly including an anvil assembly and a hammer assembly configured to impart a torque impulse to the anvil assembly, the hammer assembly including a drum assembly defining an inner surface, and the anvil assembly including an anvil defining a slot and a longitudinal bore having a hexagonal region and a circular region disposed inwardly from the hexagonal region, the hexagonal region configured to receive the tool bit, a plug received into the longitudinal bore, a blade assembly including a blade at least partially received into the slot and a first spring biasing the blade toward the inner surface of the drum assembly, and an ejection mechanism configured to eject the tool bit from the anvil, the ejection mechanism including a second spring and a plunger each positioned in the circular region; wherein a diameter of the plunger is greater than a width of the hexagonal region.

The disclosure provides, in another aspect, a power tool configured to deliver torque impulses to a tool bit, the power tool including: a housing; a drive assembly including an electric motor supported within the housing, the electric motor having an outer rotor at least partially surrounding an inner stator, and an impulse assembly supported within the housing and configured to be driven by the electric motor to rotate about an axis, wherein the impulse assembly includes an anvil assembly and a hammer assembly configured to impart a torque impulse to the anvil assembly, the hammer assembly including a drum assembly defining an inner surface, and the anvil assembly including an anvil including an output end configured to removably support the tool bit, the anvil defining a longitudinal bore, a plug received into the longitudinal bore, and a blade assembly including a blade held by the anvil and a spring biasing the blade toward the inner surface of the drum assembly; wherein the power tool defines a length measured along the axis between an end of the anvil and an end of the housing; wherein the drive assembly is configured to impart a maximum torque to the tool bit; wherein the length is less than or equal to 115 millimeters; and wherein the maximum torque is greater than or equal to 650 inch-pounds.

Other aspects of the disclosure will become apparent by consideration of the detailed description and accompanying drawings.

### BRIEF DESCRIPTION OF THE DRAWINGS

FIG. 1 is a perspective view of a power tool according to an embodiment of the present disclosure.

FIG. 2 is a side view showing the power tool of FIG. 1 with portions removed.

FIG. 3 is a cross-sectional view of the power tool of FIG. 1, taken along line 3-3 of FIG. 1.

FIG. 4 is a perspective view of a drive assembly of the power tool of FIG. 1.

FIG. 5 is a partially exploded perspective view of the drive assembly of FIG. 4.

FIGS. 6A and 6B are perspective views of an impulse assembly of the power tool of FIG. 1.

FIG. 7 is a partially exploded perspective view of the impulse assembly of FIG. 6A.

FIG. 8 is an exploded view of an anvil assembly of the impulse assembly of FIG. 6A.

FIG. 9 is a cross-sectional view of the impulse assembly of FIG. 6A, taken along line 9-9 of FIG. 6A.

FIG. 10 is a cross-sectional view of the impulse assembly of FIG. 6A, taken along line 10-10 of FIG. 6A.

FIG. 11 is a detailed cross-sectional view showing portions of the impulse assembly of FIG. 6A, taken along line 9-9 of FIG. 6A.

FIG. 12A is a cross-sectional view of the impulse assembly of FIG. 6A, taken along line 12-12 of FIG. 6A and illustrating a hammer assembly oriented at a starting position relative to the anvil assembly.

FIG. 12B is a cross-sectional view of the impulse assembly of FIG. 6A, taken along line 12-12 of FIG. 6A and illustrating the hammer assembly oriented 45 degrees past the starting position relative to the anvil assembly.

FIG. 12C is a cross-sectional view of the impulse assembly of FIG. 6A, taken along line 12-12 of FIG. 6A and illustrating the hammer assembly oriented 80 degrees past the starting position relative to the anvil assembly.

FIG. 12D is a cross-sectional view of the impulse assembly of FIG. 6A, taken along line 12-12 of FIG. 6A and illustrating the hammer assembly oriented 90 degrees past the starting position relative to the anvil assembly.

FIG. 12E is a cross-sectional view of the impulse assembly of FIG. 6A, taken along line 12-12 of FIG. 6A and illustrating the hammer assembly oriented 100 degrees past the starting position relative to the anvil assembly.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

Features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the disclosure.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

### DETAILED DESCRIPTION

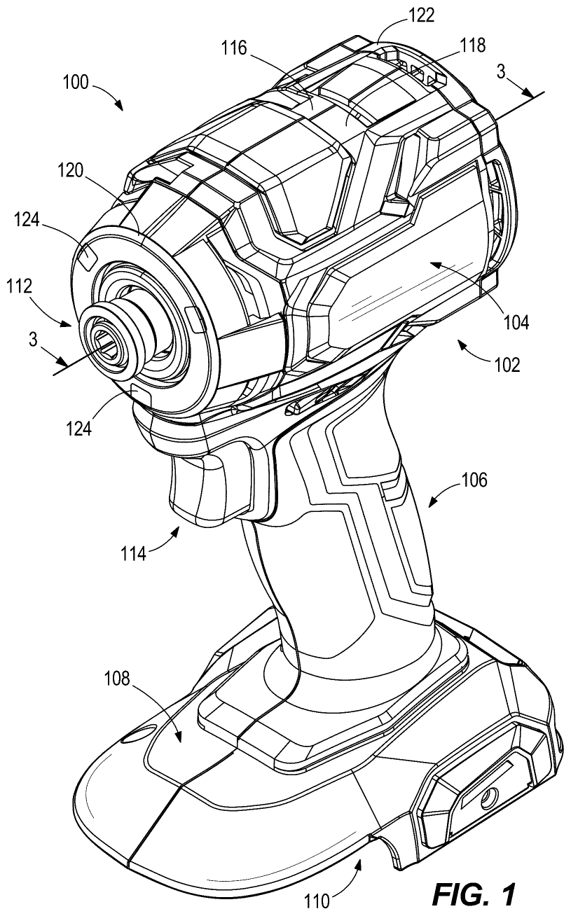

FIG. 1 illustrates a power tool embodied as an impulse driver 100. The impulse driver 100 includes a housing 102 having a motor housing portion 104, a handle portion 106, and a foot portion 108. The foot portion 108 includes a battery receptacle 110 that selectively and removably couples to a battery pack (not shown) to power the impulse driver 100. The impulse driver 100 also includes tool holder 112 which removably receives an output tool (e.g., a driver bit; not shown). The impulse driver 100 further includes a trigger 114 that, when actuated, causes the tool holder 112 to rotate (e.g., to perform a fastening operation).

In the embodiment shown in FIG. 1, the housing 102 includes a first clamshell half 116, a second clamshell half 118, a front cover 120, and a rear cover 122. The front cover 120 supports a plurality of light fixtures 124 (e.g., LED light fixtures) which are operable to light a workspace upon actuation of the trigger 114.

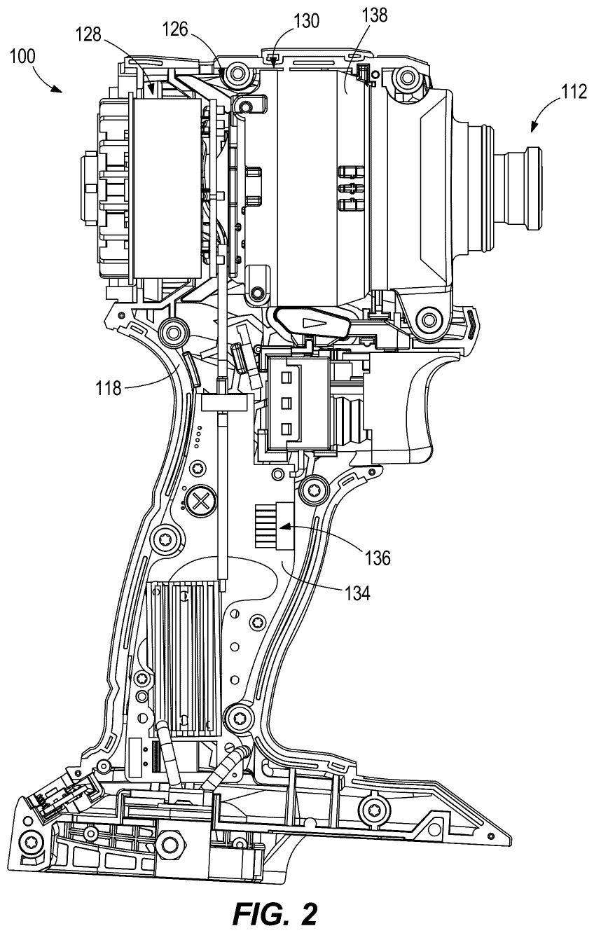

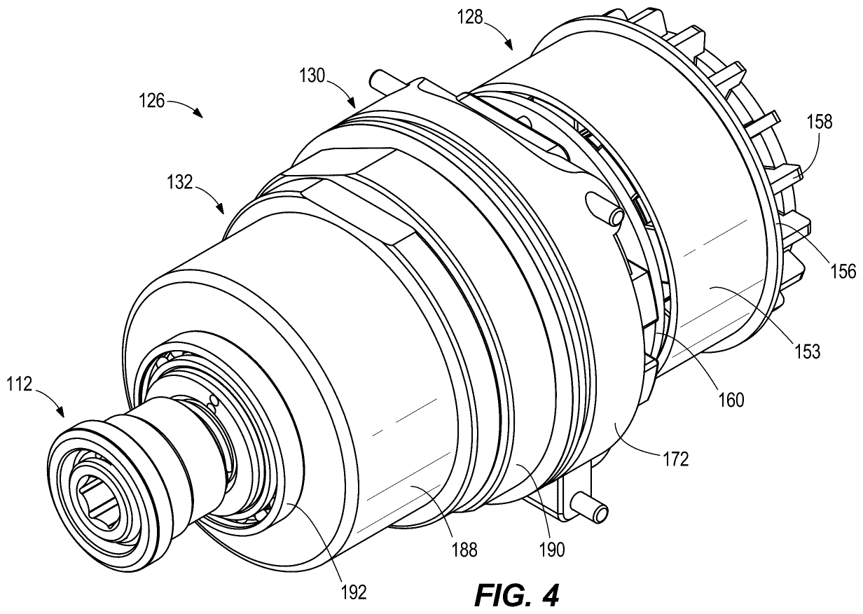

FIG. 2 illustrates the impulse driver 100 with the first clamshell half 116, the front cover 120, and the rear cover 122 removed. The impulse driver 100 includes a drive assembly 126 operable to impart torque to the tool holder 112. The drive assembly 126 includes an electric motor 128, a transmission 130, and an impulse assembly 132 (FIG. 4). The impulse driver 100 also includes a printed circuit board assembly 134 (PCBA 134) which supports a controller 136. The controller 136 is operable to control multiple aspects of the impulse driver 100, such as operation of the electric motor 128 and the plurality of light fixtures 124. For example, the controller 136 is operable to deliver electric current to the electric motor 128 to cause the electric motor 128 to start, accelerate, decelerate, or stop. The impulse driver 100 also includes an annular case 138 positioned adjacent the front cover 120 and between the clamshell halves 116, 118. The annular case 138 supports the transmission 130 and at least partially supports the electric motor 128. The annular case 138 also rotatably supports the impulse assembly 132.

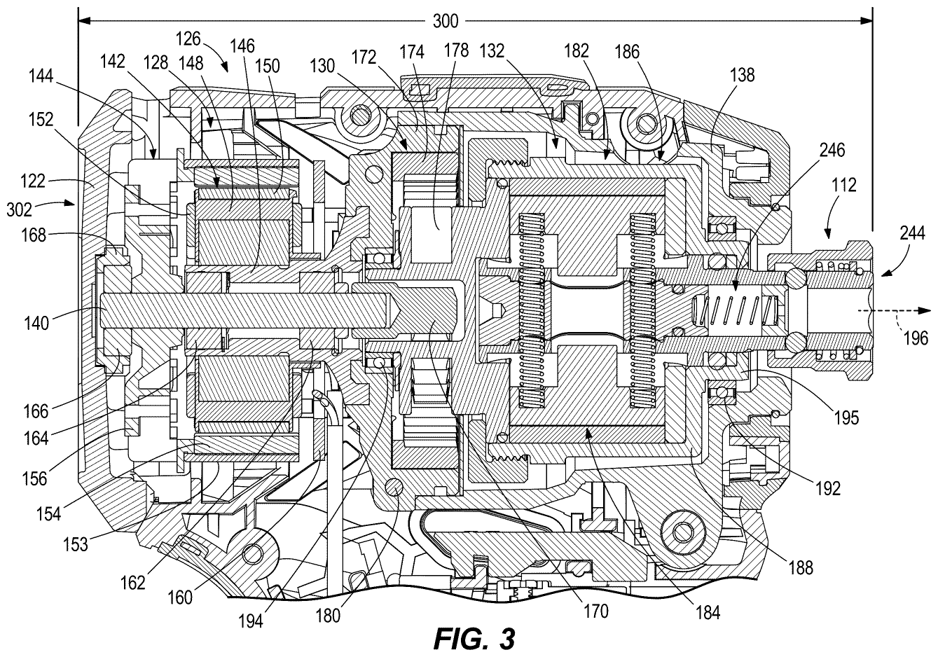

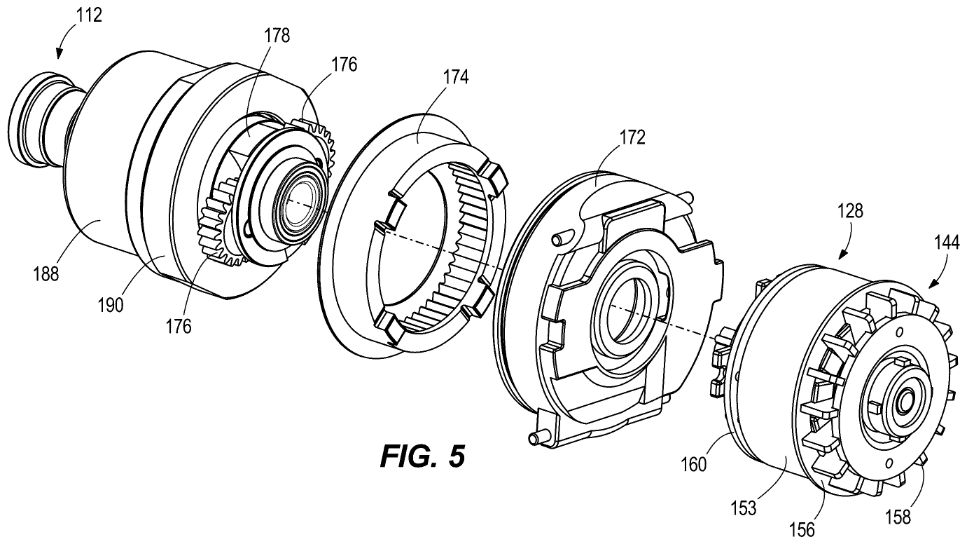

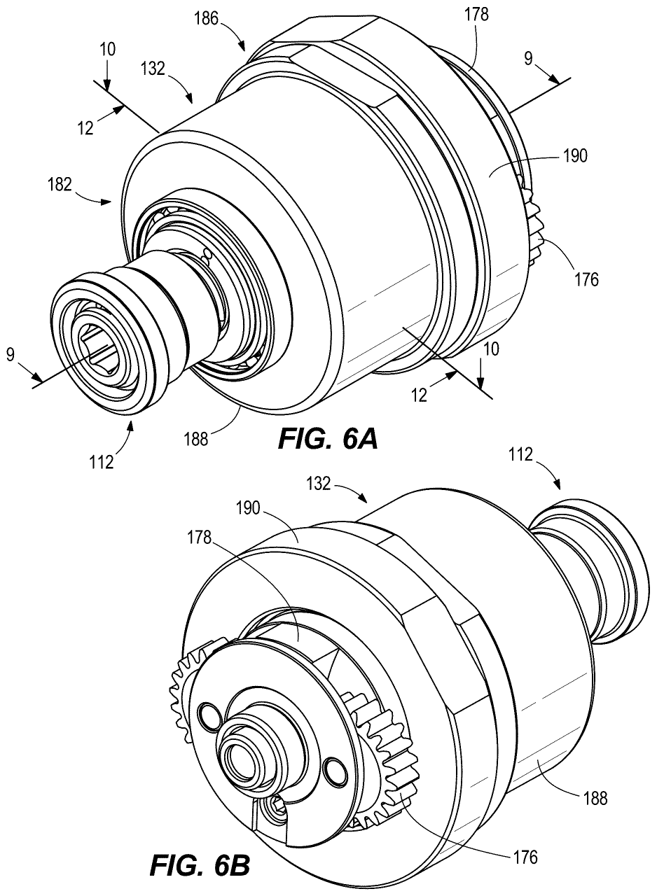

With reference to FIGS. 3-6B, the electric motor 128 is a brushless, direct-current electric motor 128 having a motor shaft 140, an inner stator 142, and an outer rotor 144 affixed to the motor shaft 140 for co-rotation therewith. The outer rotor 144 partially surrounds the inner stator 142. The inner stator 142 includes a stator mount 146, a stator core 148 fixedly supported about the stator mount 146, an insulator 150, and a plurality of coils 152 supported on the insulator 150 and the stator core 148. The outer rotor 144 includes a ring-shaped rotor body 153 supporting a plurality of permanent magnets 154, and a rotor frame 156 fixedly connecting the rotor body 153 to the motor shaft 140 for co-rotation therewith. The rotor frame 156 includes a plurality of fan blades 158 which generate a cooling airflow within the housing 102. The electric motor 128 further includes a sensor board 160 which is operable to detect a rotational position of the outer rotor 144 and communicate a position signal to the controller 136 (FIG. 2).

The outer rotor/inner stator arrangement of the electric motor 128 enables the electric motor 128 to produce a relatively high torque output relative to its axial length. This affords several advantages to the impulse driver 100 as compared to traditional impulse drivers employing traditional inner rotor/outer stator arrangements. In particular, a total axial length of the electric motor 128 is less than that of traditional inner rotor/outer stator motors of prior art impulse drivers, which allows a total axial length of the drive assembly 126 and of the impulse driver 100 to be reduced as compared to traditional impulse drivers, as will be discussed herein.

With continued reference to FIGS. 3-5, the stator mount 146 defines a central bore and supports a first motor bearing 162 and a second motor bearing 164 therein. The first and second motor bearings 162, 164 support the motor shaft 140 for rotation relative to the inner stator 142. In the illustrated embodiment, the electric motor 128 further includes a third motor bearing 166 positioned at a rear distal end of the motor shaft 140. The third motor bearing 166 is supported about its outer race by a rear bearing support 168, which is affixed to the rear cover 122. The electric motor 128 further includes an output gear 170 (e.g., a pinion), which engages the transmission 130.

The transmission 130 includes a ring gear mount 172, a ring gear 174, and planetary gears 176 which are supported by a planetary carrier 178. The ring gear mount 172 is fixedly secured to the case 138 (e.g., via pins 180 in the illustrated embodiment). The ring gear mount 172 is also fixedly secured to the stator mount 146. In the illustrated embodiment, the ring gear mount 172 is secured to the stator mount 146 by a molding process during which the ring gear mount 172 is formed about an end portion of the stator mount 146. The planetary gears 176 mesh with the output gear 170 and with the ring gear 174. The transmission 130 effects a rotational speed reduction from the motor shaft 140 to the planetary carrier 178 (and to the impulse assembly 132), and a corresponding torque increase therebetween.

With continued reference to FIGS. 3-6B, the impulse assembly 132 includes a hammer assembly 182 and an anvil assembly 184. The hammer assembly 182 includes a drum assembly 186 having a drum 188, the planetary carrier 178, and a nut 190 which secures the planetary carrier 178 to the drum 188. The drum assembly 186 is rotatably supported by the case 138 and by the ring gear mount 172. Specifically, the impulse driver 100 includes a front bearing 192 and a rear bearing 194 supported by the case 138 and the ring gear mount 172, respectively, and each rotatably supporting the drum assembly 186. The front bearing 192 has an outer race supported by a front portion of the case 138, and an inner race which supports a front portion, or nose 195, of the drum 188. The rear bearing 194 has an outer race supported by the ring gear mount 172 and an inner race which supports the planetary carrier 178. When the electric motor 128 is activated, torque is transmitted from the motor shaft 140 to the hammer assembly 182, causing the hammer assembly 182 to rotate about an output axis 196 relative to the case 138 and the ring gear mount 172.

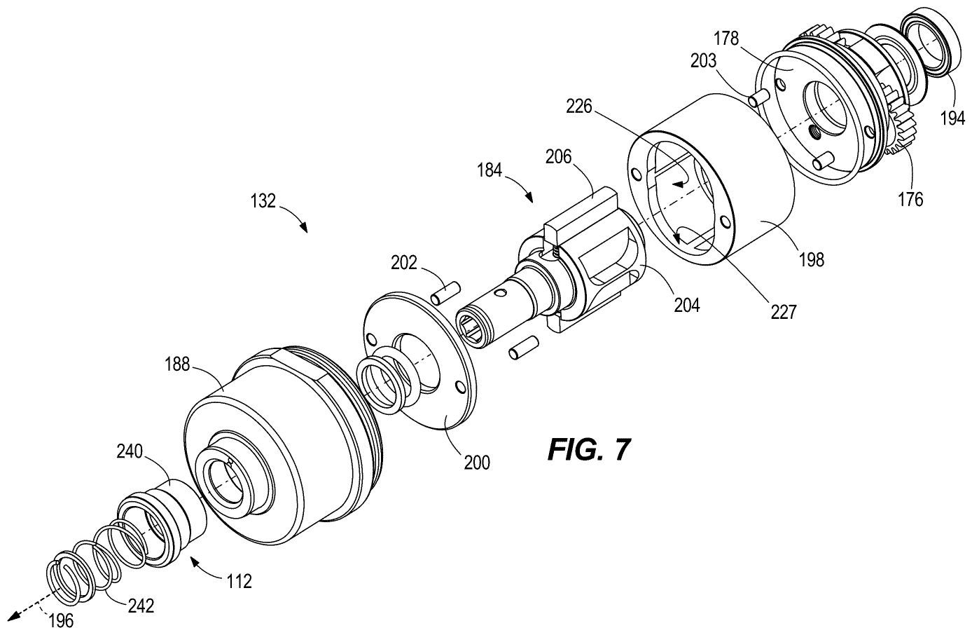

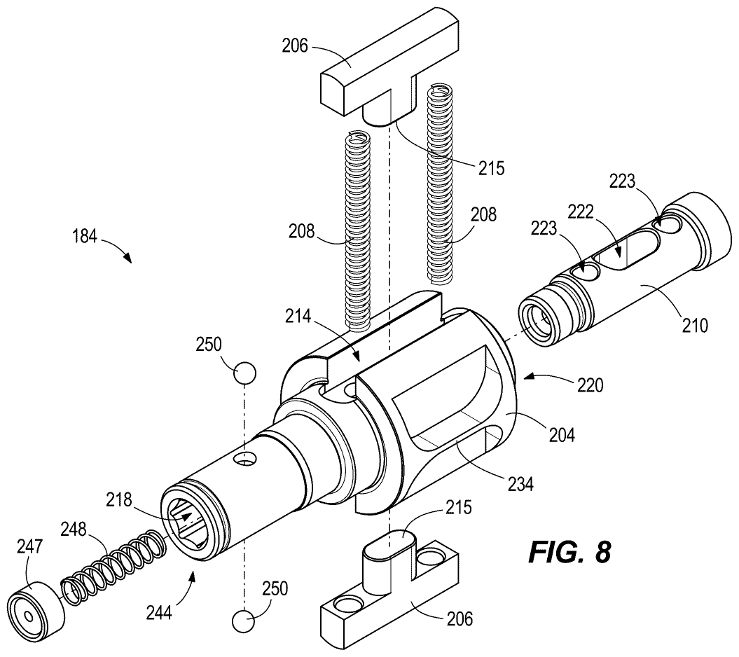

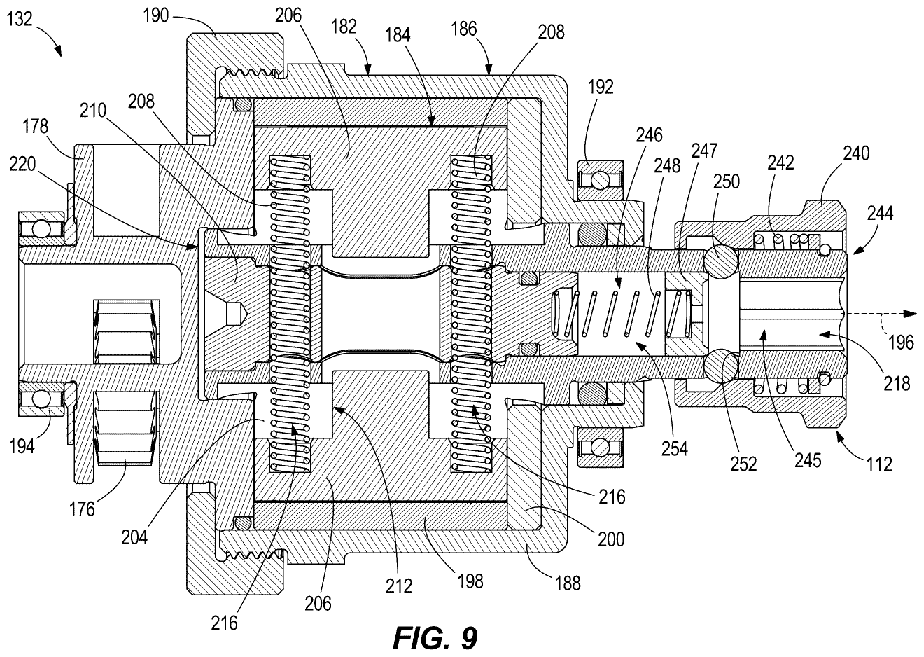

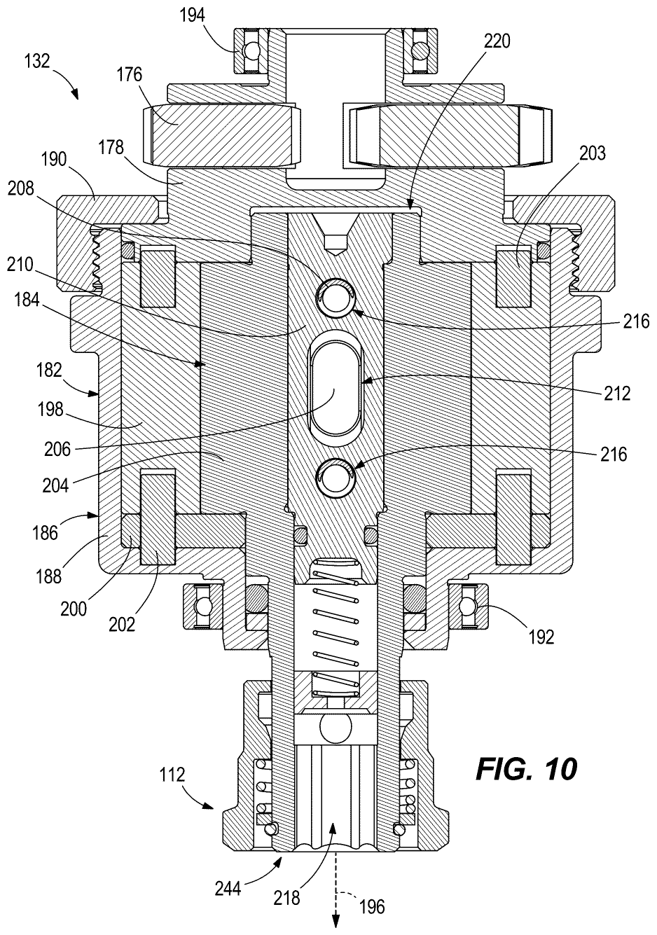

With reference to FIGS. 7-10, in addition to the drum assembly 186, the hammer assembly 182 further includes a hammer sleeve 198 received within the drum 188 and a washer plate 200 received within the drum 188. The washer plate 200 is located between the hammer sleeve 198 and a front wall of the drum 188. The drum 188, the hammer sleeve 198, and the washer plate 200 are rotationally unitized to one another by a pair of first pins 202 (FIG. 10). The planetary carrier 178 and the hammer sleeve 198 are likewise rotationally unitized to one another by a pair of second pins 203.

The anvil assembly 184 includes an anvil 204, a pair of blades 206, a pair of springs 208, and a plug 210. The anvil 204 defines a first transverse aperture 212 and a pair of longitudinal slots 214 located on either lateral side of the anvil 204. The blades 206 are received into the first transverse aperture 212 and the longitudinal slots 214. Specifically, each blade 206 includes a post 215, and the first transverse aperture 212 at least partially receives the post 215. The anvil 204 also defines a pair of second transverse apertures 216 that each receive the springs 208, respectively. The springs 208 bias the blades 206 radially outward, i.e., outward from the slots 214. The anvil 204 also defines a longitudinal bore 218. The plug 210 inserts into the longitudinal bore 218 from a rear end 220 of the anvil 204. The plug 210 defines a third transverse aperture 222 which aligns with the first transverse aperture 212 of the anvil 204. The plug 210 also defines a pair of fourth transverse apertures 223 which align with the second transverse apertures 216 and which receive the springs 208, respectively. Thus, the plug 210 surrounds each of the springs 208 and helps to prevent buckling of the springs 208 as they compress during operation.

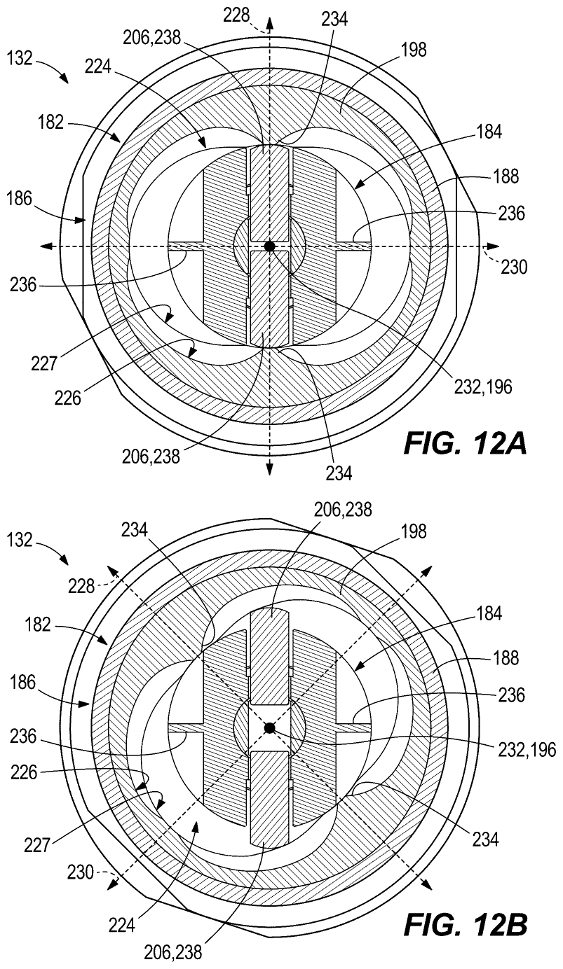

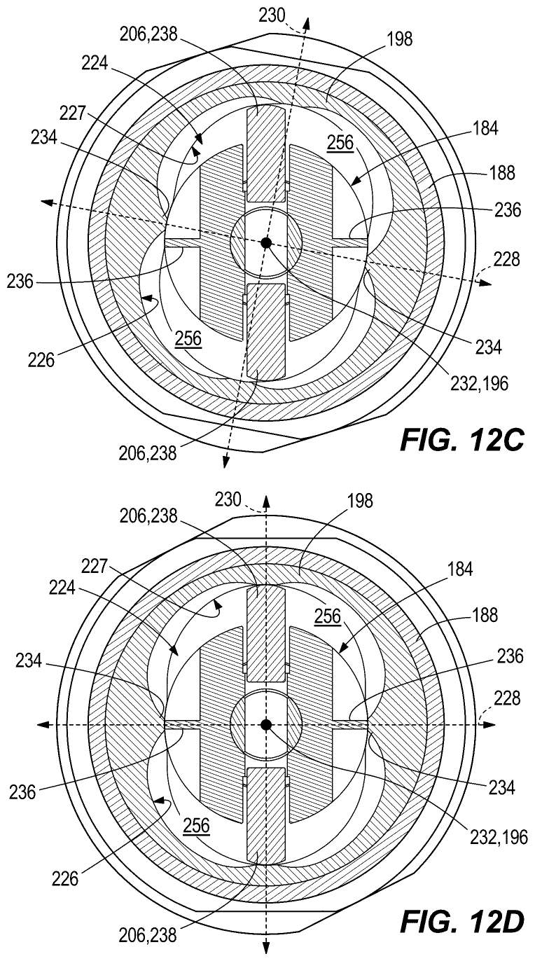

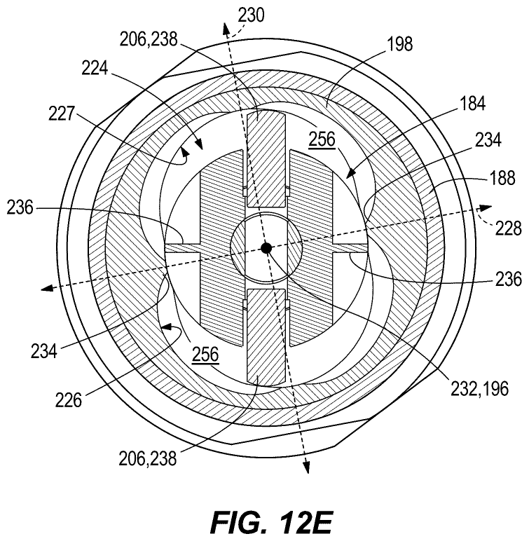

With reference to FIGS. 7, 8, and 12A, the impulse assembly 132 defines an oil chamber 224 between the hammer sleeve 198, the washer plate 200, the planetary carrier 178, and the anvil 204. The oil chamber 224 is filled with an incompressible fluid, such as oil, and is sealed to prevent the oil from escaping out of the impulse assembly 132. The hammer sleeve 198 includes a first inner surface 226 which interfaces with the anvil 204. As shown in FIG. 12A, in cross-section, the first inner surface 226 has a profile resembling an elliptical shape with a minor axis 228 and a major axis 230 extending perpendicular to the minor axis 228. The minor axis 228 and the major axis 230 intersect at a geometric center 232 of the oil chamber 224. The geometric center 232 is intersected by the output axis 196 about which the hammer assembly 182 rotates. The first inner surface 226 is partially defined by a pair of protruding ridges 234 located opposite from one another with respect to the geometric center 232 and each being centered with respect to the minor axis 228.

As shown in FIGS. 7 and 12A, the hammer sleeve 198 also includes a second inner surface 227, or a blade guide surface, which interfaces with the blades 206. The second inner surface 227 is located axially outward of the first inner surface 226. As shown in FIG. 12A, in cross-section, the second inner surface 227 also has a profile resembling an elliptical shape having minor and major axes 228, 230. The second inner surface 227 is also partially defined by the protruding ridges 234 and includes regions located radially inward from the first inner surface 226, i.e., nearer to the geometric center 232.

The anvil 204 includes a pair of seal walls 236 located opposite from one another protruding radially outward. Each seal wall 236 is located 90 degrees away from the longitudinal slots 214 and from the blades 206 with respect to the output axis 196. Each of the blades 206 is biased radially outward from the longitudinal slots 214 by the springs 208. The blades 206 include end faces 238 which remain in contact with or close proximity with the second inner surface 227 at all times, due to the biasing force of the springs 208.

With reference to FIGS. 7-11, the tool holder 112 includes a sleeve 240 and an outer spring 242 disposed on an output end 244 of the anvil 204. The output end 244 includes a hexagonal region 245 of the longitudinal bore 218, which receives a corresponding hexagonally-shaped portion of the driver bit (not shown). The power tool 100 also includes an ejection mechanism 246 also having a plunger 247 and an inner spring 248 disposed within the longitudinal bore 218 of the anvil 204. The tool holder 112 further includes a pair of ball detents 250 residing within apertures defined in the output end 244. The outer spring 242 biases the sleeve 240 toward a locked position at which an inner surface of the sleeve 240 biases the ball detents 250 radially inward, to engage and hold the driver bit within the hexagonal region 245 of the output end 244. The output end 244 also includes a shoulder 252 which faces axially rearward and is located where the hexagonal region 245 transitions to a circular region 254 of the output end 244. The plunger 247 is slidably disposed in the circular region 254. The inner spring 248 resides between the plunger 247 and the plug 210. The inner spring 248 biases the plunger 247 toward the shoulder 252, which acts as a stopping surface establishing a forwardmost position of the plunger 247. When the driver bit is held in the tool holder 112 and the sleeve 240 is retraced from the locked position to a released position, the ball detents 250 translate radially outward and away from the driver bit. The ball detents 250 thereby release the driver bit for removal from the output end 244. The plunger 247 then forces the driver bit to eject from the output end 244 under the biasing force of the inner spring 248.

The plug 210 enables significant length reduction of the power tool 100 by shortening a length of the ejection mechanism 246 as compared to traditional oil impulse driver designs. This length savings is realized by shortening the plunger 247, which allows a length of the circular region 254 to be correspondingly reduced. The shortened plunger 247 is possible because the plug 210 permits the plunger 247 to be installed from the rear end 220 of the anvil 204 during assembly, rather than from the output end 244 as is traditionally done. If the plunger were installed from the output end 244, it must be sufficiently narrow to fit through the hexagonal region 245 which has a smaller width than the circular region 254. By inserting the plunger 247 from the rear end 220, a diameter of the plunger 247 can nominally match a diameter of the circular region, which yields a more stable and secure sliding fit. The tighter dimensions allow a length of the plunger 247 to be reduced. A corresponding length of the circular region 254 can also be reduced for the same reason. The plug 210 may then be subsequently installed to retain the plunger 247 and the inner spring 248 within the circular region 254.

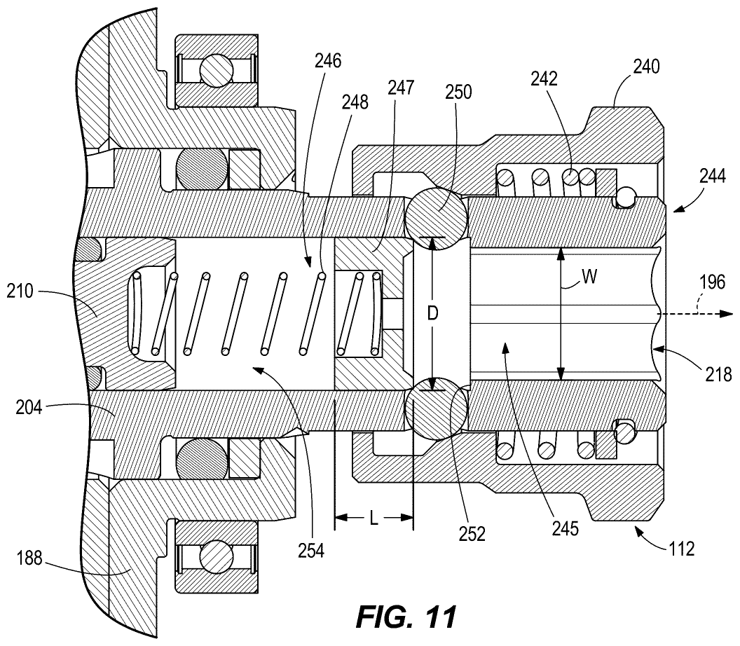

With reference to FIG. 11, the hexagonal region 245 defines a width W measured perpendicularly between two opposing flat surfaces of the hexagonal region 245. The plunger defines a diameter D, and a length L measured parallel to the output axis 196. The diameter D is greater than the width W. The Diameter D is also greater than the length L.

Operation of the impulse assembly 132 may be described as follows. FIG. 12A illustrates the hammer assembly 182 oriented at a starting position relative to the anvil assembly 184. When the electric motor 128 is activated, the motor shaft 140 rotates, which causes the hammer assembly 182 to rotate as torque from the motor shaft 140 is transmitted to the hammer assembly 182 via the transmission 130. As the hammer assembly 182 rotates, torque is transmitted to the anvil assembly 184 via the oil within the oil chamber 224. The anvil assembly 184 is coupled to the output tool (e.g., the driver bit) via the tool holder 112 and transmits torque to a working member (e.g., a fastener). As the fastener is tightened into a workpiece, it resists tightening and exerts a reactionary torque against the anvil assembly 184, causing the anvil assembly 184 to resist or cease co-rotation with the hammer assembly 182, such that the hammer assembly 182 rotates relative to the anvil assembly 184.

FIG. 12B shows the hammer assembly 182 rotated counter-clockwise 45 degrees from the starting position of FIG. 12A and relative to the anvil assembly 184. As the hammer assembly 182 rotates, the springs 208 maintain the blades 206 in close contact with the second inner surface 227. The blades 206 sweep the oil within the oil chamber 224 such that the oil resists moving with the hammer assembly 182. A pressure of the oil causes torque to be transmitted from the hammer assembly 182 to the anvil assembly 184. However, the oil pressure is relatively low at this stage of rotation as there are no sealed spaces developing between the hammer assembly 182 and the anvil assembly 184. Thus, the hammer assembly 182 may rotationally accelerate relative to the anvil assembly 184 at this stage of operation and acquire increasing angular momentum.

FIG. 12C shows the hammer assembly 182 rotated counter-clockwise 80 degrees from the starting position of FIG. 12A and relative to the anvil assembly 184. In this position, the seal walls 236 are approaching the protruding ridges 234, such that a restricted flow pathway is developing between the seal walls 236 and the protruding ridges 234. As the blades 206 continue to sweep the oil within the oil chamber 224, the flow of the oil between the seal walls 236 and the 234 becomes restricted. This causes a pressure of the oil within high pressure regions 256 to increase. The increase of the oil pressure in the high pressure regions 256 causes more torque to be transmitted, via the oil, from the hammer assembly 182 to the anvil assembly 184. In other words, the rising pressure within the high pressure regions 256 initiates an impulse of torque delivered from the hammer assembly 182 to the anvil assembly 184, and ultimately to the fastener via the driver bit.

FIG. 12D shows the hammer assembly 182 rotated counter-clockwise 90 degrees from the starting position of FIG. 12A and relative to the anvil assembly 184. In this position, the seal walls 236 seal against the protruding ridges 234, preventing the oil from flowing therebetween. Both seal walls 236 seal simultaneously against both respective protruding ridges 234. The oil pressure within the high pressure regions 256 reaches a maximum as the blades 206 continue sweeping the oil in a direction against the rotation of the hammer assembly 182. The maximum spike in oil pressure at this position results in a maximum torque delivery from the hammer assembly 182 to the anvil assembly 184, such that the anvil assembly 184 strongly tends to co-rotate with the hammer assembly 182. However, if the reactionary torque of the fastener is sufficiently high, the high oil pressure can cause the oil to escape from the high pressure regions 256 by flowing between the blades 206 and the first inner surface 226. The high pressure of the oil may cause the blades 206 to partially or nominally retract into the longitudinal slots 214, thereby creating a space between the blades 206 and the first inner surface 226 through which the oil can escape from the high pressure regions 256.

FIG. 12E shows the hammer assembly 182 rotated counter-clockwise 100 degrees from the starting position of FIG. 12A and relative to the anvil assembly 184. In this position, the protruding ridges 234 have rotated past the seal walls 236 such that a flow pathway has reopened therebetween. As the blades 206 continue sweeping the oil within the oil chamber 224, the oil may now escape the high pressure regions 256 by flowing between protruding ridges 234 and the seal walls 236. The oil pressure within the high pressure regions 256 therefore begins to recede and the impulse of torque delivered from the hammer assembly 182 to the anvil assembly 184 weakens.

As the hammer assembly 182 continues rotating relative to the anvil assembly 184 beyond the position shown in FIG. 12E, the hammer assembly 182 again begins to accelerate and acquire increasing angular momentum. The protruding ridges 234 will eventually begin approaching the seal walls 236 again (at approximately 270 degrees from the starting position of FIG. 12A), causing the oil pressure to again to build within the high pressure regions 256 and resulting in a second impulse of torque delivery from the hammer assembly 182 to the anvil assembly 184. Thus, the impulse assembly 132 generates two torque impulses per revolution of the hammer assembly 182 relative to the anvil assembly 184.

With reference to FIG. 12A, the hammer sleeve 198 is symmetrical about the minor axis 228 and about the major axis 230. The two protruding ridges 234 are located 180 degrees opposite from one another. The anvil 204 is also formed symmetrically. That is, at the starting position shown in FIG. 12A, the anvil 204 is also symmetrical about the minor axis 228 and about the major axis 230. The two seal walls 236 are located 180 degrees opposite from one another. The two blades 206 are also located 180 degrees opposite from one another and are oriented 90 degrees away from the two seal walls 236, respectively. The symmetric structure of the hammer sleeve 198 and of the anvil 204 results in the two torque impulses per revolution of the hammer assembly 182 relative to the anvil assembly 184 as described herein.

Referring again to FIG. 3, the features of the impulse driver 100 described herein, such as, e.g., the inner rotor/outer stator arrangement of the electric motor 128, the plug 210 within the longitudinal bore 218 of the anvil 204, and other features, contribute to significant length savings as compared to impulse drivers of the prior art. In particular, the impulse driver 100 defines an axial length 300 measured along the output axis 196 between the output end 244 of the anvil 204 and a rear end 302 of the housing 102. More specifically, the axial length 300 is measured between the output end 244 and the rear cover 122. In the illustrated embodiment, the axial length is less than or equal to 114.13 millimeters. In some embodiments, the axial length can be less than or equal to 115 millimeters, 110 millimeters, 105 millimeters, 100 millimeters, 90 millimeters, 80 millimeters, or 70 millimeters.

The impulse assembly 132 is also capable of delivering relatively high torque impulses to the tool bit as compared to prior art tools, particularly in relation to the relatively short axial length 300 of the power tool 100. For example, the drive assembly 126 disclosed herein is capable of delivering a maximum torque to the tool bit of greater than or equal to 650 inch-pounds. In some embodiments, the maximum torque delivered to the tool bit can be less than or equal to 750 inch-pounds, or 850 inch-pounds, or 1000 inch-pounds.

Although the disclosure has been described in detail with reference to certain preferred embodiments, variations and modifications exist within the scope and spirit of one or more independent aspects of the disclosure as described.

Various features of the disclosure are set forth in the following claims.

1. A power tool configured to deliver torque impulses to a tool bit, the power tool comprising:
a housing;
a motor supported within the housing; and
an impulse assembly supported within the housing and configured to be driven by the motor, the impulse assembly including an anvil assembly and a hammer assembly configured to impart a torque impulse to the anvil assembly, the hammer assembly including a drum assembly defining an inner surface, and the anvil assembly including
an anvil including an output end configured to removably support the tool bit, the anvil defining a longitudinal bore, a slot, and a first transverse aperture,
a plug received into the longitudinal bore, the plug defining a second transverse aperture, and
a blade assembly including a blade at least partially received into the slot and a spring extending through the first transverse aperture and the second transverse aperture, the spring biasing the blade toward the inner surface of the drum assembly.

2. The power tool of claim 1, wherein:
the inner surface defines a first longitudinal ridge and a second longitudinal ridge each protruding inwardly from opposite sides of the drum assembly;
the anvil defines a first seal wall and a second seal wall each protruding outwardly from opposite sides of the anvil;
the hammer assembly is configured to rotate relative to the anvil assembly; and
the hammer assembly is configured to deliver the torque impulse to the anvil assembly when the first longitudinal ridge seals against the first seal wall and the second longitudinal ridge seals against the second seal wall.

3. The power tool of claim 2, wherein the first and second longitudinal ridges seal against the first and second seal walls simultaneously.

4. The power tool of claim 1, further comprising:
an ejection mechanism configured to eject the tool bit from the anvil, the ejection mechanism including an ejection spring and a plunger;
wherein the anvil defines:
a hexagonal region of the longitudinal bore, the hexagonal region configured to receive the tool bit;
a circular region of the longitudinal bore disposed inwardly from the hexagonal region; and
a shoulder located between the hexagonal region and the circular region;
wherein the shoulder establishes a forwardmost position of the plunger.

5. The power tool of claim 4, wherein the plunger is configured to slide within the circular region, and wherein the ejection spring biases the plunger toward the shoulder.

6. The power tool of claim 5, wherein the ejection spring is positioned between the plunger and the plug.

7. The power tool of claim 6, wherein the ejection spring contacts the plug.

8. A power tool configured to deliver torque impulses to a tool bit, the power tool comprising:
a housing;
a motor supported within the housing; and
an impulse assembly supported within the housing and configured to be driven by the motor, the impulse assembly including an anvil assembly and a hammer assembly configured to impart a torque impulse to the anvil assembly, the hammer assembly including a drum assembly defining an inner surface, and the anvil assembly including
an anvil defining a slot and a longitudinal bore having a hexagonal region and a circular region disposed inwardly from the hexagonal region, the hexagonal region configured to receive the tool bit,
a plug received into the longitudinal bore,
a blade assembly including a blade at least partially received into the slot and a first spring biasing the blade toward the inner surface of the drum assembly, and
an ejection mechanism configured to eject the tool bit from the anvil, the ejection mechanism including a second spring and a plunger each positioned in the circular region;
wherein a diameter of the plunger is greater than a width of the hexagonal region.

9. The power tool of claim 8, wherein the second spring is positioned between the plug and the plunger.

10. The power tool of claim 9, wherein the second spring contacts the plug.

11. The power tool of claim 8, wherein the anvil further defines a shoulder located between the hexagonal region and the circular region, and wherein the shoulder establishes a forwardmost position of the plunger.

12. The power tool of claim 8, wherein the diameter of the plunger is greater than an axial length of the plunger.

13. The power tool of claim 8, wherein the blade includes a post, and wherein the plug defines a first transverse aperture that at least partially receives the post.

14. The power tool of claim 13, wherein:
the anvil defines a second transverse aperture;
the plug defines a third transverse aperture; and
the first spring extends through the second transverse aperture and the third transverse aperture, the first spring biasing the blade toward the inner surface of the drum assembly.

15. The power tool of claim 8, wherein:
the inner surface defines a first longitudinal ridge and a second longitudinal ridge each protruding inwardly from opposite sides of the drum assembly;
the anvil defines a first seal wall and a second seal wall each protruding outwardly from opposite sides of the anvil;
the hammer assembly is configured to rotate relative to the anvil assembly; and
the hammer assembly is configured to deliver the torque impulse to the anvil assembly when the first longitudinal ridge seals against the first seal wall and the second longitudinal ridge seals against the second seal wall.

16. The power tool of claim 15, wherein the first and second longitudinal ridges seal against the first and second seal walls simultaneously.

17. A power tool configured to deliver torque impulses to a tool bit, the power tool comprising:
a housing;
a drive assembly including
an electric motor supported within the housing, the electric motor having an outer rotor at least partially surrounding an inner stator, and
an impulse assembly supported within the housing and configured to be driven by the electric motor to rotate about an axis,
wherein the impulse assembly includes an anvil assembly and a hammer assembly configured to impart a torque impulse to the anvil assembly, the hammer assembly including a drum assembly defining an inner surface, and the anvil assembly including
an anvil including an output end configured to removably support the tool bit, the anvil defining a longitudinal bore,
a plug received into the longitudinal bore, and
a blade assembly including a blade held by the anvil and a spring biasing the blade toward the inner surface of the drum assembly;
wherein the power tool defines a length measured along the axis between an end of the anvil and an end of the housing;
wherein the drive assembly is configured to impart a maximum torque to the tool bit;
wherein the length is less than or equal to 115 millimeters; and
wherein the maximum torque is greater than or equal to 650 inch pounds.

18. The power tool of claim 17, wherein the length is greater than or equal to 70 millimeters, and wherein the maximum torque is less than or equal to 1000 inch pounds.

19. The power tool of claim 17, wherein:
the inner surface defines a first longitudinal ridge and a second longitudinal ridge each protruding inwardly from opposite sides of the drum assembly;
the anvil defines a first seal wall and a second seal wall each protruding outwardly from opposite sides of the anvil;
the hammer assembly is configured to rotate relative to the anvil assembly; and
the hammer assembly is configured to deliver the torque impulse to the anvil assembly when the first longitudinal ridge seals against the first seal wall and the second longitudinal ridge seals against the second seal wall.

20. The power tool of claim 17, further comprising:
an ejection mechanism configured to eject the tool bit from the anvil, the ejection mechanism including an ejection spring and a plunger;
wherein the anvil defines:
a hexagonal region of the longitudinal bore, the hexagonal region configured to receive the tool bit;
a circular region of the longitudinal bore disposed inwardly from the hexagonal region; and
a shoulder located between the hexagonal region and the circular region;
wherein the shoulder establishes a forwardmost position of the plunger.
